(19) United States
(12) Patent Application Publication
(10) Pub. No.: US 2006/0014545 A1
(43) Pub. Date: Jan. 19, 2006

(54) Using multiple receive antenna to determine the location of a transmitter with respect to a receiver in ultra wideband systems

(76) Inventors: Shaomin Samuel Mo, Monmouth Junction, NJ (US); Alexander D. Gelman, Smallwood, NY (US)

Correspondence Address: RATNERPRESTIA, P O BOX 980, VALLEY FORGE, PA, 19482-0980, US

(21) Appl. No.: 10/516,575

(22) PCT Filed: Dec. 16, 2003
(86) PCT No.: PCT/US03/40224

§ 371 Date: Jun. 28, 2005

Related U.S. Application Data
(60) Provisional application No. 60/433,920, filed on Dec. 16, 2002.
(60) Provisional application No. 60/451,506, filed on Mar. 3, 2003.

(51) Int. Cl. H04Q 7/20

(52) U.S. Cl. 455/456.1; 455/436

(57) ABSTRACT

An apparatus, system, method, and computer program product for determining a location of at least an image of a transmitter transmitting a signal is disclosed. The location of at least the image of the transmitter is determined by receiving a signal transmitted by the transmitter at at least three receiver antennas separated by known distances. Differences in time are then determined between receipt of the signal at one of the receiver antennas and at least two other receiver antennas. The known distances and the determined differences in receipt times are then processed to determine the location of the transmitter.

### RELATED APPLICATIONS

This application claims the benefit of the filing dates of U.S. Provisional Application No. 60/433,920 entitled “USING MULTIPLE RECEIVE ANTENNAS TO ESTIMATE PROPAGATION DISTANCES BETWEEN TRANSMITTERS AND RECEIVERS IN WIRELESS COMMUNICATIONS SYSTEMS” filed Dec. 16, 2002 and U.S. Provisional Application No. 60/451,506 entitled “USING MULTIPLE RECEIVE ANTENNAS TO ESTIMATE POSITIONS OF IMAGES OF TRANSMITTERS IN A UWB COMMUNICATION SYSTEM” filed Mar. 3, 2003, the contents of each incorporated herein by reference.

### FIELD OF THE INVENTION

The present invention relates to wireless communications systems and, more particularly, to methods and apparatus for determining the location of a transmitter or an image of the transmitter with respect to a receiver having multiple antennas.

### BACKGROUND OF THE INVENTION

Wireless communication systems such as wireless personal area network systems (e.g. PAN systems) are becoming increasingly popular. PAN systems are based on ad hoc networks. In a typical ad hoc network, the individual nodes within a group of nodes that make up the network are mobile (e.g., portable wireless devices). Routing is performed at the network level and entails having each node maintain routing information about every other node. The nodes can dynamically hand off from one sub-network to another when they move. A good measurement or estimation of the distance between the mobile terminal and the sub-networks is desirable to make the hand off management both effective and efficient.

In current wireless communications systems, distances between transmitters and receivers are estimated by measuring the strength of received signals. The measurements, however, may be inaccurate due to unreliable wireless channels.

Ultra Wideband (UWB) technology is presently being introduced in radar systems and ad hoc networking. UWB uses base-band pulses of very short duration spread over a wide band of frequencies to spread the energy of transmitted signals very thinly from near zero Hz to several GHz. The techniques for generating UWB signals are well known. UWB technology has been used for military applications for many years. Commercial applications will soon become possible due to a recent decision announced by the Federal Communications Commission (FCC) that permits the marketing and operation of certain new types of consumer products incorporating UWB technology. The key motivation for the FCC's decision to allow commercial applications is that no new spectrum is required for UWB transmissions because, when they are properly configured, UWB signals can coexist with other application signals in the same spectrum with negligible mutual interference. In addition, the use of UWB in radar systems is expected to provide improvements in resolution.

Recently Multiple Input & Multiple Output (MIMO) technology has attracted attentions in wireless applications. MIMO systems use multiple transmitter antennas and/or receiver antennas to achieve diversity gain, spectral efficiency gain and interference suppression. MIMO technology has been proposed to UWB systems to resolve multi-path and multi-user problems in wireless systems. An exemplary MIMO system is described in an article by L. Yang et al. entitled “Space-Time Coding for Impulse Radio,” 2002 IEEE Conference on Ultra Wideband Systems and Technologies, May 2002. MIMO systems, however, are subject to the same limitations as the wireless communication system described above with respect to determining distances between transmitters and receivers.

There is an ever present desire for better wireless networks and radar systems. One way of improving these systems is to more accurately determine the location of transmitters with respect to receivers. Accordingly, methods and systems are needed for more accurately determining the location of a transmitter relative to a receiver that are not subject to the above limitations and are compatible with UWB application. The present invention fulfill this need among others.

### SUMMARY OF THE INVENTION

The present invention is embodied in an apparatus, system, method, and computer program product for determining a location of at least an image of a transmitter transmitting a signal. The location of at least the image of the transmitter is determined by receiving a signal transmitted by the transmitter at a plurality of receiver antennas separated by known distances. Differences in time are then determined between receipt of the signal at one of the plurality of antennas and at least two other antennas. The known distances and the determined differences in receipt times are then processed to determine the location of the transmitter.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. Included in the drawings are the following figures:

FIG. 1 is a topological diagram showing the relative positions between a receiver and a transmitter.

FIG. 2 is a topological diagram which is useful for describing problems associated with reflection of signals in estimating a distance between a receiver and a transmitter.

FIGS. 3A and 3B are topological diagrams which are useful for describing location ambiguity when multiple receiver antennas are used to receive a signal transmitted by a single transmitter.

FIGS. 4, 5, and 6 are topological diagrams showing relative positions of a transmitter and three receiver antennas that are useful for describing the operation of an exemplary embodiment of the invention.

FIG. 7 is a topological diagram showing possible positions of a transmitter relative to the three receiver antennas calculated according to the present invention.

FIGS. 8, 9, and 10 are topological diagrams showing possible positions of a transmitter relative to a receiver having four antennas in accordance with the present invention.

FIG. 11 is a block diagram of a network in accordance with the present invention.

FIG. 12 is a flow chart of exemplary steps for determine a location of a transmitter in accordance with the present invention.

FIG. 13 is an illustrative representation of network including sub-networks in accordance with the present invention.

FIG. 14 is an illustrative representation of a personal area network system in accordance with the present invention.

### DETAILED DESCRIPTION

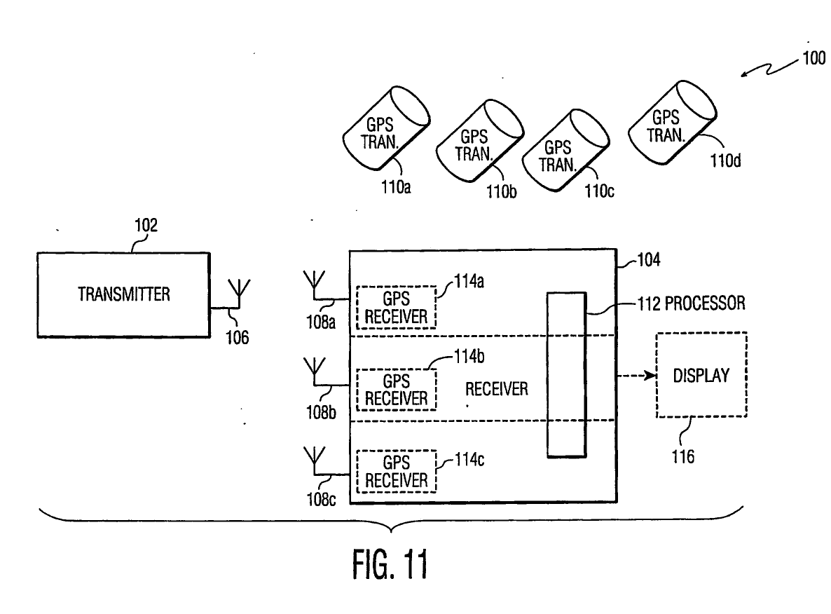

FIG. 11 depicts an exemplary communication system 100 capable of determining the location (e.g., distance and/or position) of a transmitter 102 with respect to a receiver 104, e.g., signal propagation distances between the transmitter 102 and the receiver 104, in accordance with the present invention. In general overview, a signal transmitted by the transmitter 102 via a transmitter antenna 106 is received at the receiver 104 via multiple receiver antennas 108a-c, which have a predefined relationship to one another. A location of at least an image of the transmitter 102 is then determined by processing differences in receive times of the signal by the multiple receiver antennas 108a-c and the predefined distances therebetween. If the receiver antennas 108a-c are in a single device, or in relatively close proximity to one another, a centralized timer (not shown) may provide necessary timing information. Optionally, if the antennas are relatively far apart, global positioning system (GPS) transmitters 110a-d may be used to synchronize local time bases in the receiver 104 and/or predetermine the distances between receiver antennas 108a-c. The communication system 100 is now described in detail.

The transmitter 102 transmits signals through an antenna 106. As described in further detail below, reflections of the signals (for example, by a wall) result in the transmitter appearing to be located in a different location than where it is physically located. These apparent locations are referred to as images of the transmitter. In an exemplary embodiment, the transmitter is a Ultra Wideband (UWB) transmitter that transmits UWB pulse signals. It is contemplated that in addition to UWB, the present invention may be practiced with essentially any wireless communication system or radar system in which it is desirable to determine the distance or position of a transmitter (or transmitter image) relative to a receiver as long as the wireless communication system can provide adequate timing resolution for the intended application.

In an alternative exemplary embodiment, the transmitter 102 is a reflective body (not shown). For example, in a radar system, signals are directed into an area and reflections from reflective bodies (e.g., a boat hull or a human being) within that area are assimilated to determine the location of those reflective bodies. The reflective bodies reflect signals as if they are the transmission source and, thus, behave as a transmitter.

The receiver 104 receives signals from the transmitter 102 via the plurality of receiver antennas 108a-c. The distances between one of the receiver antennas 108 and at least two other receiver antennas 108 is known. In addition, the receiver is configured to associate a respective time at which the signal was received by each antenna. For example, a timer (not shown) within the receiver 104 that is controlled by a processor 112 may be used to determine the respective time, which the processor 104 associates with a particular antenna. As described in further detail below, the processor 112 processes the respective times and the known distances to determine a location of the transmitter 102 with respect to the receiver 104. In an exemplary embodiment, the receiver 104 is a UWB receiver with the antennas 108 and processor 112 of the receiver 104 configured to process UWB signals. In alternative exemplary embodiments, essentially any wireless communication or radar medium may be used. A suitable receiver for use in the present invention will be understood by those skilled in the art from the description herein.

In the illustrated embodiment, there are three receiver antennas 106a-c, which are substantially in a straight line. In an exemplary embodiment, the receiver antennas are omni-directional antennas. In an alternative exemplary embodiment, one or more of the antennas may be directional antennas. The distances between one of the receiver antennas and each of the other antennas are known. For example, the distances between a first receiver antenna, e.g., receiver antenna 106a, and each of the remaining antennas 106b and 106c may be determined. In an exemplary embodiment, the distances between the antennas are fixed at the time of manufacture or deployment. In alternative exemplary embodiments, the distance between antennas may be adjustable or may vary, but are known at the time measurements are made to determine the location of the transmitter.

The receiver 104 may be a single receiver with a plurality of antennas 108. Alternatively, the receiver 104 may be multiple receivers (represented by dashed lines dividing the receiver 104 into three parts, i.e., representing three receivers). If multiple receivers are used, each receiver 104 includes its own processor (further represented by the dashed line passing through the processor 112. The multiple receivers are desirably synchronized prior to determining transmitter locations. In addition, if the multiple receivers vary in position with respect to one another, the multiple receivers are synchronized prior to determining the distances between the receivers.

In an exemplary embodiment, each receiver may include a GPS receiver 114a-c for receiving GPS time signals from known GPS transmitters 110a-d. The GPS time signals may be use to synchronize the local time bases in the receiver(s). In addition, assuming adequate resolution, the processor can determine the distances between the receiver antennas based on GPS location information gathered by each receiver for assembly by a common processor.

A conventional display 116 may be coupled to the receiver to present determined location information, e.g., a numeric or graphical representation. For example, in a wireless network, the locations (e.g., distance and/or direction) of a plurality of sub-networks that are based on transmissions received from the sub-networks may be presented to a user to enable the user to select a particular sub-network in the direction the user is traveling. In another example, the location (e.g., position) of a reflective body with respect to the receiver in a radar system may be displayed to a user so that the user may identify the position of the reflective body.

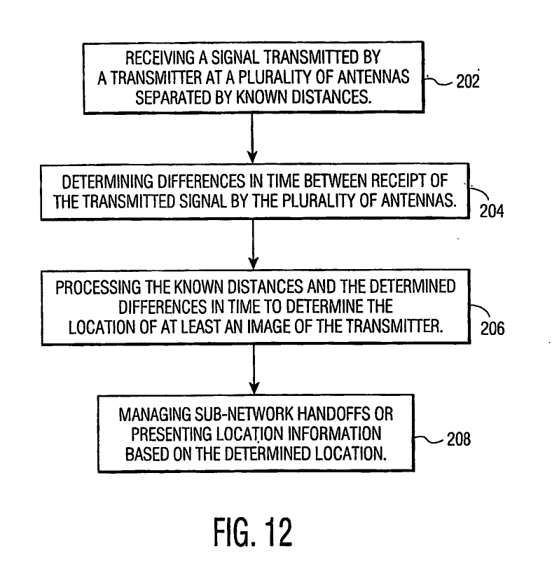

FIG. 12 depicts a flow chart 200 of exemplary steps described with reference to FIG. 11 for determining the location of a transmitter 102 with respect to a receiver 104.

At block 202, the receiver 104 receives a signal transmitted by the transmitter 102. The receiver receives the signal at a plurality of antennas 108 that are separated by known distances. As described above, the known distance may be defined at the time the receiver is manufactured or deployed or may be determined by the processor 112, e.g., based on internal timers (not shown) or based on timing and/or location information received through GPS receivers 114 from GPS transmitters 110.

At block 204, the processor 112 determines differences in time between receipt of the transmitted signal by the plurality of antennas 108. When a signal is received at the antennas 108 of the receiver 104, a respective time for the receipt is associated with the antenna 108 through which it was received. For example, the processor 112 may determine the difference in time between a signal received at a first antenna and each of a second and third antenna. In addition, differences in time between these antennas and other antennas, such as a fourth antenna, may also be determined. In an exemplary embodiment, the times are referenced to a synchronized local time base in the receiver 104.

At block 206, the processor 112 processes the known distances between antennas and the determined differences in time to find the location of at least an image of the transmitter. If the distance between one of the receive antennas and each of two other receive antennas is known and the difference in time of receipt of a signal by each of the antennas is known, the distance to at least an image of the transmitter may be determined. Greater resolution in determining the distance or in determining the position of the image may be achieved through the use of additional antennas and processing respective times and distances associated with those antennas.

As described herein, the transmitter 102 is assumed to be substantially co-located with the transmitter antenna 106. Thus, determining the location of the transmitter antenna 106 determines the location of the transmitter 102 as well. In addition, where one receiver is used, or multiple receiver that are coupled together, the receiver(s) 104 is assumed to be substantially co-located with the receiver antennas 108. Thus, determining the location of the transmitter antenna 106 with respect to the receiver antennas 108 effectively determines the location of the transmitter 102 with respect to the receiver 104. Extending the present invention to encompass situations were the transmitter 102 and/or receiver 104 and their respective antennas 106, 108 are not co-located will be understood by those of skill in the art.

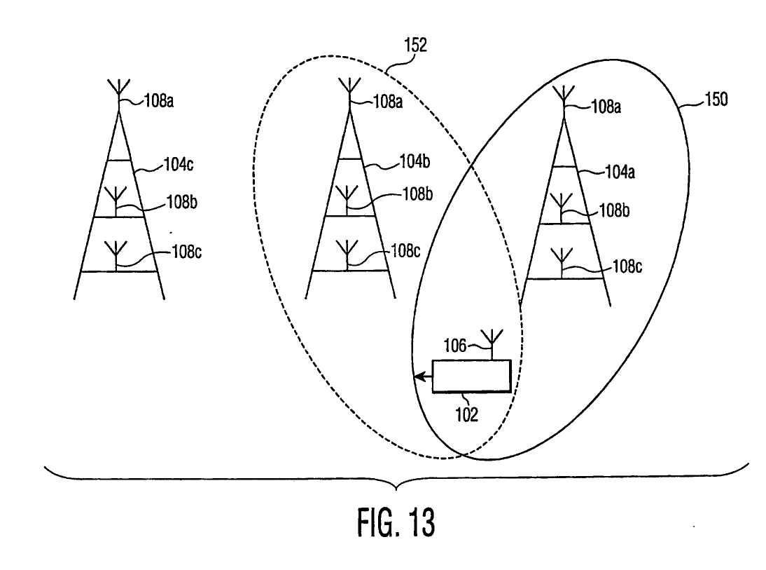

At block 208, the processor 112 manages network handoffs or presents location information (e.g., via the display 116) based on the determined location. In an exemplary embodiment, the determined location is used for network management, which is described below with reference to FIG. 13. In an alternative exemplary embodiment, the present invention may be used in ad-hoc networks, radar systems, or essentially any system in which it may be useful to determine the distance between a transmitter or transmitter image and a receiver.

FIG. 13 is an illustrative diagram of an exemplary use of the present invention. In the illustrated embodiment, a mobile transmitter 102, e.g., a cellular telephone in an automobile, is in communication with a first receiver 104a, e.g., a cellular telephone tower. The transmitter 102 and the receiver 104a together form a first sub-network 150. As the transmitter 102 moves away from the first receiver 104a toward a second receiver 104b and a third receiver 104c, it is desirable for the transmitter 102 to establish a new connection with one of the other receivers to form a new sub-network. In an exemplary embodiment of the present invention, the first receiver 104a determines the location of the transmitter 102 based on the receipt times of a signal at each antenna in that receiver 104a. Based on stored information in the first receiver 104a, the first receiver 104a then determines if the location of the transmitter 102 is closer to the second receiver 104b or the third receiver 104c. Assuming the second receiver 104b is determined to be closer, the first receiver 104a hands off communication to the second receiver 104b (forming a new sub-network 152) rather than requiring the exchange of signals between the transmitter 102 and each receiver 104 in the area. Various other embodiments will be understood by those of skill in the art from this embodiment and the remainder of the detailed description.

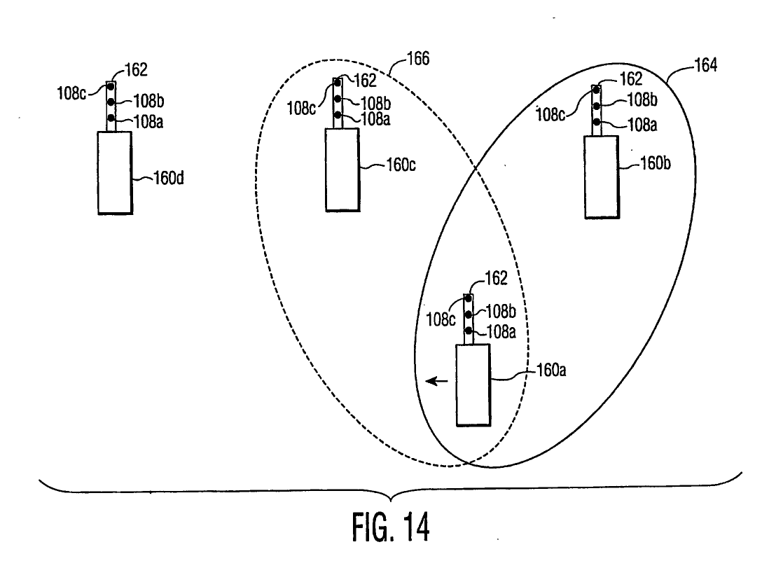

FIG. 14 is an illustrative diagram of another exemplary use of the present invention. In the illustrated embodiment, mobile wireless communication devices 160a-d, such as cellular telephones or portable computers, are capable of communicating with one another to establish personal area networks (PAN). Each of the wireless communication devices may include an antenna apparatus 162 including at least a first antenna 108a, a second antenna 108b, and a third antenna 108c. At least one of the antennas 108 may be used for transmission and at least three antennas 108 may be used for reception.

In an exemplary embodiment, at least one of the communication devices, e.g., communication device 160a, is able to determine the location of one or more of the other communication devices 160b-d. In accordance with this embodiment, to determine the location of the other communication devices 160b-d, communication device 160a behaves as a receiver 104 having a plurality of receiver antennas 108 and the other communication devices behave as transmitters 102. In an exemplary embodiment, communication device 160a periodically monitors the location of the other communication device 160b-d and establishes a PAN with the communication device that is closest in the direction the communication device is moving. For example, communication device 106a may be in a PAN 164 including communication device 160b. As the communication device 160a moves, the communication device determines the location of the closest communication device in the direction it is traveling, e.g., communication device 160c. The communication device 160a may then establish a new PAN 166 including communication device 160c.

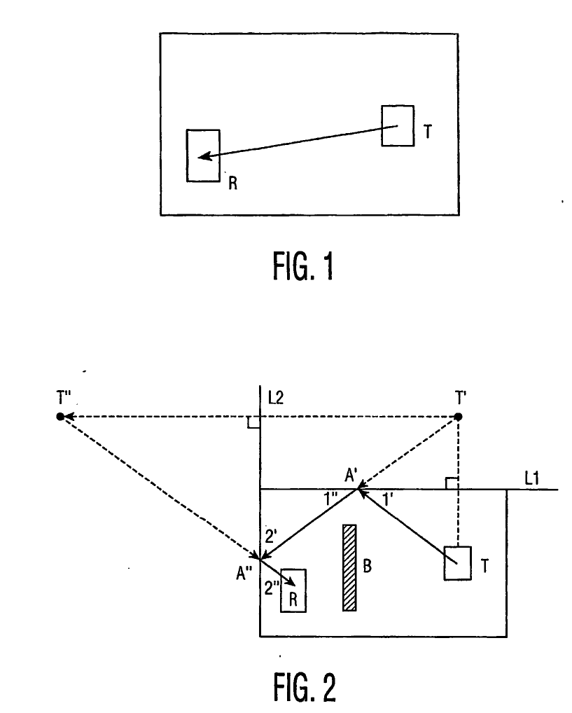

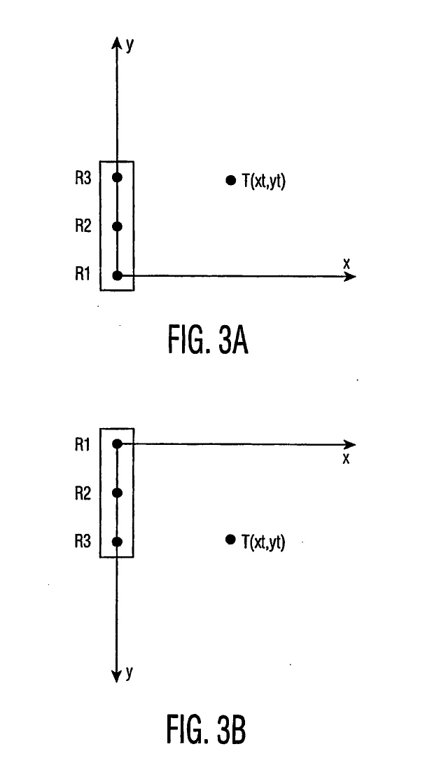

Additional technical support for determining the location of a transmitter with respect to a receiver having multiple receiver antennas is now described in further detail. Wireless signals are propagated in air from transmitters, T, to receivers, R. The propagation path may be direct as shown in FIG. 1 or it may be reflected when obstacles block direct propagation as shown in FIG. 2. In FIG. 1, the propagation distance is the distance between the transmitter, T, and the receiver, R. In FIG. 2, the propagation distance is the distance between R and T″ (i.e., the image of T′ reflected from axis L2 at point A″, where T′ is the image of transmitter T reflected from axis L1 at point A′). The total distance between the transmitter, T, and the receiver, R, is the summation of T-A′, A′-A″ and A″-R. This relationship can be expressed by equation (1).
dist_{R-T″}=dist_{R-A″}+dist_{A″-T′}=dist_{R-A″}+dist_{A″-A′}+dist_{A′-T′} (1)

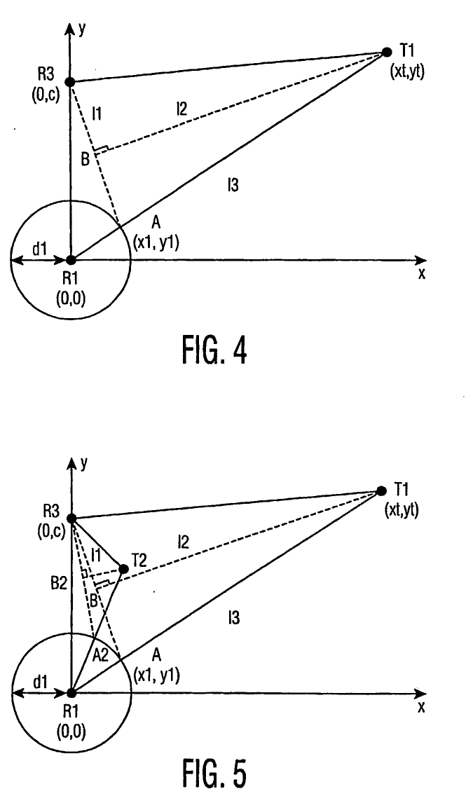

FIGS. 3A and 3B show two possible positions of a transmitter T(xt,yt) relative to a receivers R1, R2, and R3. The difference is whether T(xt,yt) is above R2 in its y-coordinate, as shown in FIG. 3A, or below R2 as shown in FIG. 3B. By properly choosing the coordinates, the terms xt and yt may both be made positive, as shown in FIG. 3A in which T(xt,yt) is always above R2.

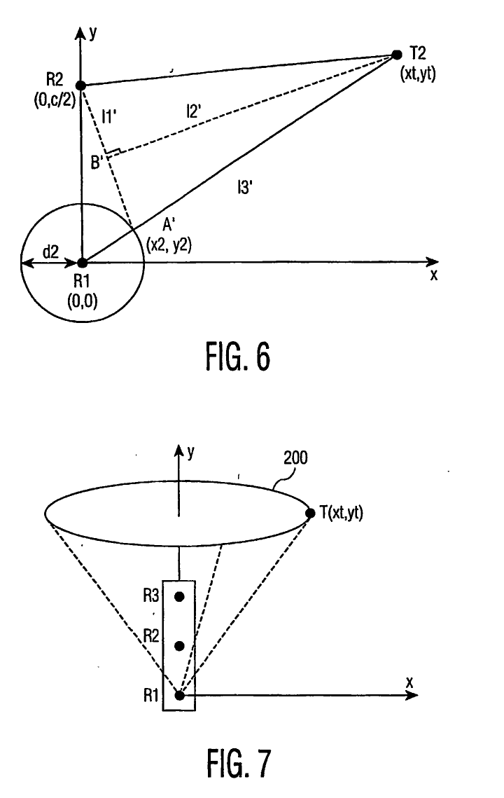

The propagation distance from T to R1 and R3 is now calculated. The coordinate system shown in FIG. 4 is chosen. In FIG. 4, T1 is the transmitter and R1 and R3 are two antennas at the receiver. Point A is marked so that dist_{T1-A}=dist_{T1-R3}.

Then a circle can be drawn which has its center is at the location of antenna R1 and has a radius d1, defined by equation (2)
d₁=dist_{R1-A}=dist_{T1-R1}−dist_{T1-A} (2)
In this problem, the values c and d₁ are known. The value c is the distance between R1 and R3, and the value d₁ is the difference in the signal propagation time between the transmitter and the two receiver antennas, R1 and R3. It is also noted that d₁≦c. When T1, R1 and R3 are on a line, or when T1 is on the y axis with xt=0, d₁=c.

The circle can be expressed by equation (3)
x²+y²=d₁² (3)
Line l₁ passes through R3(0,c) and A(x₁,y₁). It can be expressed as shown in equation (4).

$$y = \frac{{y}_{1} - c}{{x}_{1}} x + c \qquad ( 4 )$$

Point B is the middle point between R3(0,c) and A(x₁, y₁), therefore its location is

$$( \frac{{x}_{1}}{2} , \frac{c + {y}_{1}}{2} ) .$$

Line l₂ is perpendicular to line l₁ at point B. Hence it can be expressed by equation (5)

$$\begin{matrix}y = \frac{{x}_{1}}{c - {y}_{1}} x + \frac{{c}^{2} - {x}_{1}^{2} - {y}_{1}^{2}}{2 ( c - {y}_{1} )} \\ = \frac{{x}_{1}}{c - {y}_{1}} x + \frac{{c}^{2} - {d}_{1}^{2}}{2 ( c - {y}_{1} )}\end{matrix} \qquad ( 5 )$$

Line l₃ passes through R1(0,0) and A(x₁, y₁). It can be expressed by equation (6)

$$y = \frac{{y}_{1}}{{x}_{1}} x \qquad ( 6 )$$

Point T1 is at the intersection of l₂ and l₃. Its location can be derived from equations (7) and (8):

$$\begin{matrix}y = \frac{{x}_{1}}{c - {y}_{1}} x \frac{{c}^{2} - {d}_{1}^{2}}{2 ( c - {y}_{1} )} & ( 7 ) \\ y = \frac{{y}_{1}}{{x}_{1}} x & ( 8 )\end{matrix}$$

The solution to these equations is given by the equations (9) is:

$$\{ \begin{matrix}{x}_{T1} = \frac{{c}^{2} - {d}_{1}^{2}}{2} \frac{{x}_{1}}{{cy}_{1} - {d}_{1}^{2}} \\ {y}_{T1} = \frac{{c}^{2} - {d}_{1}^{2}}{2} \frac{{y}_{1}}{{cy}_{1} - {d}_{1}^{2}}\end{matrix} \qquad ( 9 )$$

Because x₁ and y₁ can take any value on the circle described by equation (3), the above solution in (9) is not unique. This can also be illustrated in FIG. 5. Moving point A to point A2 on the circle, T1 moves to T2 so that
dist_{T1-R3}=dist_{T1-A}
dist_{T2-R3}=dist_{T2-A2}
which means that propagation difference between T1 to R1 and R3 is the same as that between T2 to R1 and R3 because A and A2 are on the same circle described by equation (3). A curve can be drawn between T1 and T2 to represent every possible location of the transmitter that would result in equal propagation differences between the transmitter to R1 and to R3. It is expected that if another receiver antenna is used, e.g., R2, another curve can be drawn that represents every possible location of the transmitter that would result in equal propagation differences between the transmitter to R1 and to R2. The position of the transmitter, or image of the transmitter, is then found at the intersection of the two curves.

In order to measure differences in propagation time between the transmitter and the receiver antennas, it may be desirable for the antennas to have a well-defined temporal relationship. If each antenna is coupled to a respective receiver which receives its signal separately and the time at which the signal is received is conveyed to receivers coupled to the other antennas, it may be desirable for each receiver to synchronize to a common reference, for example, signals from four or more global positioning satellites. Alternatively, the signals may be received at a single receiver from multiple antennas. In this instance, it may be desirable to measure the signal propagation time from each antenna to the receiver in order to be able to accurately estimate the times at which the various signals are received by the various antennas.

Signal propagation from T to R1 and R2 is now described in which R2 is an antenna positioned between R1 and R3. For the sake of simplicity, only R1 and R2 are shown in FIG. 6 while only R1 and R3 are shown in FIG. 5. Similar to the analysis presented above, it is noted that, with reference to FIG. 6, c/2 is the distance between R1 and R2, and d₂ is the difference in signal propagation time between the transmitter and the two receiver antennas. It is also noted that d₂≦c/2. When T1, R1, and R2 are on a line, or T1 is on the y axis with xt=0, d₂=c/2.

This circle can be expressed by equation (10)
x²+y²=d₂² (10)
Line l′₁ passes R2(0,c/2) and A′(x₂, Y₂). It can be expressed by equation (11)

$$y = \frac{{y}_{2} - \frac{c}{2}}{{x}_{2}} x + \frac{c}{2} \qquad ( 11 )$$

Point B′ is the middle point of R2(0,c/2) and A′(x₂,y₂). Therefore its location is

$$( \frac{{x}_{2}}{2} , \frac{c / 2 + {y}_{2}}{2} ) .$$

Line l′₂ is perpendicular to line l′₁ and passes point B′. Hence it can be expressed by equation (12)

$$y = \frac{{x}_{2}}{c / 2 - {y}_{2}} x + \frac{{c}^{2} / 4 - {d}_{2}^{2}}{c - 2 {y}_{2}} \qquad ( 12 )$$

Line l′₃ passes R1(0,0) and A′(x₂,y₂). It can be expressed by equation (13)

$$y = \frac{{y}_{2}}{{x}_{2}} x \qquad ( 13 )$$

Point T2 is at the intersection of l′₂ and l′₃. Its location can be derived from the equations (14):

$$\{ \begin{matrix}y = \frac{{x}_{2}}{c / 2 - {y}_{2}} x + \frac{{c}^{2} / 4 - {d}_{2}^{2}}{c - 2 {y}_{2}} \\ y = \frac{{y}_{2}}{{x}_{2}} x\end{matrix} \qquad ( 14 )$$

The solution to equation (14) is shown in equations (15):

$$\{ \begin{matrix}{x}_{T2} = ( \frac{{c}^{2}}{4} - {d}_{2}^{2} ) \frac{{x}_{2}}{{cy}_{2} - 2 {d}_{2}^{2}} \\ {y}_{T2} = ( \frac{{c}^{2}}{4} - {d}_{2}^{2} ) \frac{{y}_{2}}{{cy}_{2} - 2 {d}_{2}^{2}}\end{matrix} \qquad ( 15 )$$

Because T1 and T2 are in fact the same point in the system, the relationships shown in equations (16) hold.

$$\{ \begin{matrix}{x}_{T1} = {x}_{T2} \\ {y}_{T1} = {y}_{T2} \\ {x}_{T1}^{2} + {y}_{T1}^{2} = {x}_{T2}^{2} + {y}_{T2}^{2}\end{matrix} \qquad ( 16 )$$

Substituting (9) and (15) into (16) gives equations (17).

$$\{ \begin{matrix}\frac{{c}^{2} - {d}_{1}^{2}}{2} \frac{{x}_{1}}{{cy}_{1} - {d}_{1}^{2}} = ( \frac{{c}^{2}}{4} - {d}_{2}^{2} ) \frac{{x}_{2}}{{cy}_{2} - 2 {d}_{2}^{2}} \\ \frac{{c}^{2} - {d}_{1}^{2}}{2} \frac{{y}_{1}}{{cy}_{1} - {d}_{1}^{2}} = ( \frac{{c}^{2}}{4} - {d}_{2}^{2} ) \frac{{y}_{2}}{{cy}_{2} - 2 {d}_{2}^{2}} \\ \frac{{( {c}^{2} - {d}_{1}^{2} )}^{2}}{4} \frac{{d}_{1}^{2}}{{( {cy}_{1} - {d}_{1}^{2} )}^{2}} = {( \frac{{c}^{2}}{4} - {d}_{2}^{2} )}^{2} \frac{{d}_{2}^{2}}{{( {cy}_{2} - 2 {d}_{2}^{2} )}^{2}}\end{matrix} \qquad ( 17 )$$

Equation (18) follows from the second and third of the equations (17).

$${y}_{2} = \frac{{ⅆ}_{2}}{{ⅆ}_{1}} {y}_{1} \qquad ( 18 )$$

Substituting equation (18) into the second of the equations (17) leads to equation (19):

$$\frac{{c}^{2} - {d}_{1}^{2}}{2} \frac{{y}_{1}}{{cy}_{1} - {d}_{1}^{2}} = ( \frac{{c}^{2}}{4} - {d}_{2}^{2} ) \frac{\frac{{ⅆ}_{2}}{{ⅆ}_{1}} {y}_{1}}{c \frac{{ⅆ}_{2}}{{ⅆ}_{1}} {y}_{1} - 2 {d}_{2}^{2}} \qquad ( 19 )$$

Equation (19) can be further simplified as equations (20) and (21).

$$\begin{matrix}\frac{{c}^{2} - {d}_{1}^{2}}{2} \frac{1}{{cy}_{1} - {d}_{1}^{2}} = ( \frac{{c}^{2}}{4} - {d}_{2}^{2} ) \frac{{d}_{2}}{{cd}_{2} {y}_{1} - 2 {d}_{1} {d}_{2}^{2}} & ( 20 ) \\ ( {c}^{2} - {d}_{a}^{2} ) ( {cd}_{2} {y}_{1} - 2 {d}_{1} {d}_{2}^{2} ) = 2 {d}_{2} ( \frac{{c}^{2}}{4} - {d}_{2}^{2} ) ( {cy}_{1} - {d}_{1}^{2} ) & ( 21 )\end{matrix}$$

y₁ can be obtained from equation (21) as shown in equation (22):

$${y}_{1} = \frac{2 {d}_{1} [ {d}_{2} ( {c}^{2} - {d}_{1}^{2} ) - {d}_{1} ( {c}^{2} / 4 - {d}_{2}^{2} ) ]}{c ( {c}^{2} / 2 - {d}_{1}^{2} + 2 {d}_{2}^{2} )} \qquad ( 22 )$$

Equation (23) then follows from equation (22):

$${cy}_{1} - {d}_{1}^{2} = \frac{{d}_{1} [ 2 {c}^{2} {d}_{2} - 2 {d}_{1}^{2} {d}_{2} - {c}^{2} {d}_{1} + {d}_{1}^{3} ]}{{c}^{2} / 2 - {d}_{1}^{2} + 2 {d}_{2}^{2}} \qquad ( 23 )$$

Substituting (23) into the left side of the third equation of equations (17) gives a distance, dist, between the transmitter and the receiver that can be described by equation (24).

$$\begin{matrix}dist = \frac{( {c}^{2} - {d}_{1}^{2} )}{4} \frac{{d}_{1}^{2}}{{( {cy}_{1} - {d}_{1}^{2} )}^{2}} \\ = \frac{{( {c}^{2} - {d}_{1}^{2} )}^{2}}{4} \frac{{( {c}^{2} / 2 - {d}_{1}^{2} + 2 {d}_{2}^{2} )}^{2}}{{( 2 {c}^{2} {d}_{2} - 2 {d}_{1}^{2} {d}_{2} - {c}^{2} {d}_{1} + {d}_{1}^{3} )}^{2}}\end{matrix} \qquad ( 24 )$$

The distance is expressed in terms of three known values
c—the distance between the receiver antennas R1 and R3 and
d₁—the propagation difference between the transmitter and the receiver antennas R1 and R3.
d₂—the propagation difference between the transmitter and the receiver antennas R1 and R2.

In fact, x_{T} and y_{T} can also be calculated by using (3) and (9) as shown in equations (25)

$$\{ \begin{matrix}{y}_{T} = \frac{{c}^{2} - {d}_{1}^{2}}{2} \frac{{y}_{1}}{{cy}_{1} - {d}_{1}^{2}} \\ {x}_{T} = \frac{{c}^{2} - {d}_{1}^{2}}{2} \frac{\sqrt{{d}_{1}^{2} - {y}_{1}^{2}}}{{cy}_{1} - {d}_{1}^{2}}\end{matrix} \qquad ( 25 )$$

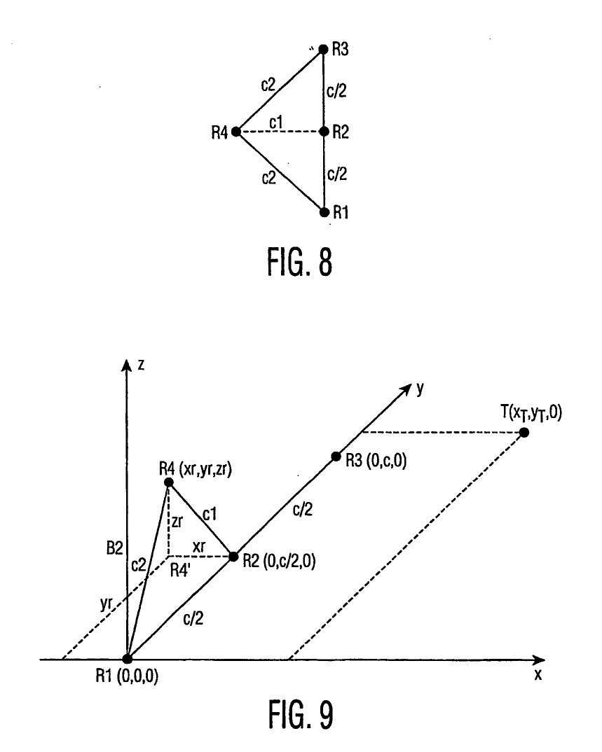

When T(x_{T},y_{T}) rotates around the axes R1-R2-R3, a circle is formed shown in FIG. 7. The points on this circle have the same distance to R1, R2, and R3 respectively. Thus, in this situation, the distance may be determined, but the position of the transmitter T cannot be uniquely determined.

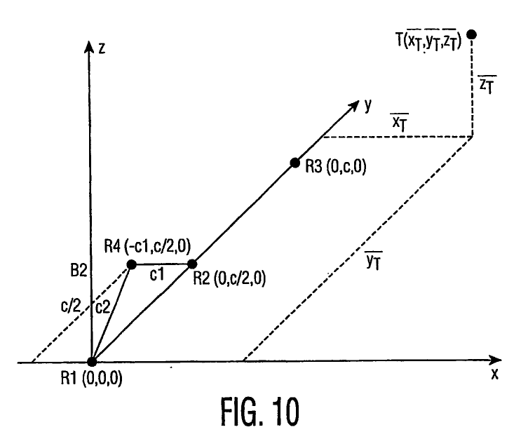

FIG. 8 is a topology diagram of an alternative exemplary embodiment for more precisely determining the location to include the position of the transmitter T. FIG. 8 indicates the relative positions of four antenna elements R1, R2, R3, and R4 according to the present invention, which are coupled to a receiver (not shown). The antennas R1, R2 and R3 are on the same line and, thus, in the same plane, as shown in FIG. 8. In this example, R1 is separated from R3 by a distance c, and R2 which is between R1 and R3 is separated from both R1 and R3 by a distance c/2. Antenna R4 is separated from antennas R1 and R3 by a distance c2 and from antenna R2 by a distance c1. The relationship shown in equation (26) may be derived from FIG. 8.
c₂²=c₁²+c²/4 (26)
A coordinate system is selected such that the receive antennas R1, R2 and R3 and the transmitter T are in the same plane shown in FIG. 9 so that z_{T}=0. The distance between T and R1 may be defined by equation (27).

$$\begin{matrix}{d}_{T - R1}^{2} = {x}_{T}^{2} + {y}_{T}^{2} + {z}_{T}^{2} \\ = {x}_{T}^{2} + {y}_{T}^{2}\end{matrix} \qquad ( 27 )$$

and distance between T and R4 may be defined by equation (28).

$$\begin{matrix}{d}_{T - R4}^{2} = {( {x}_{T} - {x}_{r} )}^{2} + {( {y}_{T} - {y}_{r} )}^{2} + {( {z}_{T} - {z}_{r} )}^{2} \\ = {( {x}_{T} - {x}_{r} )}^{2} + {( {y}_{T} - c / 2 )}^{2} + {z}_{r}^{2}\end{matrix} \qquad ( 28 )$$

The difference, Δ, between d_{T-R1} and d_{T-R4} can be derived from equations (27) and (28) as shown in equation (29).

$$\begin{matrix}Δ = {d}_{T - R4}^{2} - {d}_{T - R1}^{2} \\ = - 2 {x}_{r} {x}_{T} + {x}_{r}^{2} - {cy}_{T} + \frac{{c}^{2}}{4} + {z}_{r}^{2}\end{matrix} \qquad ( 29 )$$

In FIG. 9, the point R4′ is the image of R4 on the XOY plane. The relationship shown in equation (30) can be derived from the triangle formed by the points R4, R4′ and R2.
xᵣ²+zᵣ²=c1² (30)
Equations (31) may be derived from equations (29) and (30).

$$\{ \begin{matrix}Δ = - 2 {x}_{r} {x}_{T} + {x}_{r}^{2} - {cy}_{T} + \frac{{c}^{2}}{4} + {z}_{r}^{2} \\ {x}_{r}^{2} + {z}_{r}^{2} = {c1}^{2}\end{matrix} \qquad ( 31 )$$

Substituting the second equation of the equations (31) into the first equation (31), results in equation (32).

$$Δ = - 2 {x}_{r} {x}_{T} + {c1}^{2} - {cy}_{T} + \frac{{c}^{2}}{4} \qquad ( 32 )$$

Equations (33), describing the X and Z coordinates of the transmitter, may be derived from equation (32).

$$\{ \begin{matrix}{x}_{r} = \frac{{d}_{T - R1}^{2} - {d}_{T - R4}^{2} - {cy}_{T} + {cl}^{2} + {c}^{2} / 4}{2 {x}_{T}} \\ {z}_{r} = \pm \sqrt{{c1}^{2} - {x}_{r}^{2}}\end{matrix} \qquad ( 33 )$$

The result shown in equation (33) may be expressed in another way by rotating the coordinate around the y axes, as shown in FIG. 10 so that: \overline{xᵣ}=−c1 & \overline{zᵣ}=0, such that equations (34) hold.

$$∵ \{ \begin{matrix}\overline{{x}_{r}} = {x}_{r} cos θ + {z}_{r} sin θ = - c1 \\ \overline{{z}_{r}} = - {x}_{r} sin θ + {z}_{r} cos θ = 0\end{matrix} \qquad ( 34 )$$

From the second equation (34) it can be seen that

$$θ = arctan \frac{{z}_{r}}{{x}_{r}}$$

After this rotation, the new coordinates of T may be expressed as shown in equations (35).

$$\{ \begin{matrix} \overline{{x}_{T}} = {x}_{T} cos θ + {z}_{T} sin θ = {x}_{T} cos θ \\ \overline{{y}_{T}} = {y}_{T} \\ \overline{ {z}_{T}} = - {x}_{T} sin θ + {z}_{T} cos θ = - {x}_{T} sin θ\end{matrix} \qquad ( 35 )$$

The position of the transmitter, T, relative to the antennas R1, R2, R3, and R4 can be determined by equations (35) as T(\overline{x_{T}}, \overline{y_{T}}, \overline{z_{T}}).

This invention concerns a mechanism to estimate the location of at least images of transmitters, such as UWB transmitters in UWB communications systems. No line of sight propagation path is required. No transmission from the receivers is needed. In MIMO systems, the same receiver antennas can be used and very limited extra calculation is needed to provide the described location functions. This invention may be used, for example, in UWB ad-hoc networks to improve performance of hand-off management and in other location aware applications.

It is contemplated that one or more of the components may be implemented in software running on a general purpose computer. In this embodiment, one or more of the functions of the various components may be implemented in software that controls the general purpose computer. This software may be embodied in a computer readable carrier, for example, a magnetic or optical disk, a memory-card or an audio frequency, radio-frequency or optical carrier wave.

In addition, although the invention is illustrated and described herein with reference to specific embodiments, the invention is not intended to be limited to the details shown. Rather, various modifications may be made in the details within the scope and range of equivalents of the claims and without departing from the invention.

The invention claimed is:

1. An apparatus for determining a location of at least an image of a transmitter transmitting a signal, the apparatus comprising:
a plurality of at least three antennas, separated by respective known distances, configured to receive the signal, each of the plurality of antennas receiving the signal at a respective time; and
a processor coupled to the plurality of antennas, the processor configured to determine the location of at least the image of the transmitter responsive to at least the respective known distances and differences among the respective times.

2. The apparatus of claim 1, wherein the apparatus is a wireless communication device configured for use in a wireless communication network including a plurality of sub-networks and wherein the processor is further configured to manage hand-offs between the sub-networks responsive to the determined location of at least the image of the transmitter.

3. The apparatus of claim 1, further comprising:
a display coupled to the processor for presenting the determined location of at least the image of the transmitter.

4. The apparatus of claim 1, wherein the signal is an Ultra Wideband (UWB) signal and wherein the plurality of antennas are configured to receive UWB signals and the processor is configured to process the UWB signals.

5. The apparatus of claim 1, wherein at least three of the plurality of antennas are in a substantially straight line.

6. The apparatus of claim 5, wherein at least one other antenna of the plurality of antennas is not in the substantially straight line.

7. The apparatus of claim 1, further comprising:
a plurality of receivers, each receiver comprising at least one of the plurality of antennas, each receiver configured to receive GPS signals; and
wherein the processor is further configured to determine the known distances responsive to the GPS signals.

8. The apparatus of claim 1, further comprising:
a plurality of receivers, each receiver comprising at least one of the plurality of antennas, each receiver configured to receive GPS time signals to synchronize local time bases in each of the receivers; and
wherein the processor is further configured to determine time differences responsive to the respective times referenced to the synchronized local time bases.

9. The apparatus of claim 1, wherein at least one of the plurality of at least three antennas is omni-directional.

10. An apparatus for determining a location of at least an image of a transmitter transmitting a signal, the apparatus comprising:
a first antenna configured to receive the signal, the first antenna receiving the signal at a first time;
a second antenna configured to receive the signal, the second antenna separated from the first antenna by a first known distance and receiving the signal at a second time;
a third antenna configured to receive the signal, the third antenna separated from the first antenna by a second known distance and receiving the signal at a third time; and
a processor coupled to the first, second, and third antennas, the processor configured to determine the location of at least the image of the transmitter responsive to at least the first and second known distances and differences between the first time and each of the second and third times.

11. The apparatus of claim 10, wherein the apparatus is a wireless communication device configured for use in a wireless communication network including a plurality of sub-networks and wherein the processor is further configured to manage hand-offs between the sub-networks responsive to the determined location of at least the image of the transmitter.

12. The apparatus of claim 10, further comprising:
a display coupled to the processor for presenting the determined location of at least the image of the transmitter.

13. The apparatus of claim 10, wherein the signal is an Ultra Wideband (UWB) signal and wherein the first, second, and third antennas are configured to receive UWB signals and the processor is configured to process the UWB signals.

14. The apparatus of claim 10, wherein the first, second, and third antennas are in a substantially straight line.

15. The apparatus of claim 14, further comprising:
a fourth antenna configured to receive the signal, the fourth antenna receiving the signal at a fourth time, not in the substantially straight line, and separated from one of the antennas by a third known distance;
wherein the processor is further coupled to the fourth antenna and configured to determine the location of at least the image of the transmitter responsive to the third known distance and differences between the fourth time and at least one of the first, second, and third times.

16. The apparatus of claim 10, further comprising:
a first receiver comprising the first antenna and the processor, the first receiver configured to receive GPS signals;
a second receiver comprising the second antenna, the second receiver configured to receive the GPS signals; and
a third receiver comprising the third antenna, the third receiver configured to receive the GPS signals; and
wherein the processor is further configured to determine the first and second known distances responsive to the GPS signals.

17. The apparatus of claim 10, further comprising:
a first receiver comprising the first antenna and the processor, the first receiver configured to receive a GPS time signal to synchronize a first local time base of the first receiver;
a second receiver comprising the second antenna, the second receiver configured to receive the GPS time signal to synchronize a second local time base of the second receiver; and
a third receiver comprising the third antenna, the third receiver configured to receive the GPS time signal to synchronize a third local time base of the third receiver; and
wherein the processor is further configured to determine time differences responsive to the first, second, and third time signals referenced to the respective first, second, and third local time bases.

18. The apparatus of claim 10, wherein at least one of the first, second, and third antennas is an omni-directional antenna.

19. A method for determining a location of at least an image of a transmitter transmitting a signal with respect to a receiver having a plurality of at least three antennas separated by known distances for receiving the signal, the method comprising the steps of:
determining differences in time between receipt of the signal at one of the plurality of antennas and at least two of the other antennas; and
processing the known distances and the determined differences in time to determine the location of at least the image of the transmitter.

20. The method of claim 19, wherein the transmitter is part of a sub-network within a network including a plurality of sub-networks and wherein the method further comprises the step of:
managing hand-offs between the sub-network and another sub-network in the plurality of sub-networks responsive to the determined location of at least the image of the transmitter.

21. The method of claim 19, further comprising the step of:
presenting the determined location of at least the image of the transmitter.

22. The method of claim 19, wherein the signal is an Ultra Wideband (UWB) signal and wherein the determining step comprises the step of:
determining differences in time among receipt of the UWB signal at the plurality of antennas.

23. The method of claim 19, further comprising the steps of:
receiving a GPS time signal to synchronize a local time base in the receiver; and
wherein the processing step comprises the step of:
determining the differences in time referenced to the synchronized local time base.

24. A system for determining a location of at least an image of a transmitter transmitting a signal with respect to a receiver having a plurality of at least three antennas separated by known distances for receiving the signal, the system comprising:
means for determining differences in time between receipt of the signal at one of the plurality of antennas and at least two of the other antennas; and
means for processing the known distances and the determined differences in time to determine the location of at least the image of the transmitter.

25. The system of claim 24, wherein the transmitter is part of a sub-network within a network including a plurality of sub-networks and wherein the system further comprises:
means for managing hand-offs between the sub-network and another sub-network in the plurality of sub-networks responsive to the determined location of at least the image of the transmitter.

26. The system of claim 24, further comprising:
means for presenting the determined location of at least the image of the transmitter.

27. The system of claim 24, wherein the signal is an Ultra Wideband (UWB) signal and wherein the determining means comprises:
means for determining differences in time among receipt of the UWB signal at the plurality of antennas.

28. The system of claim 24, further comprising:
means for receiving a GPS time signal to synchronize a local time base in the receiver; and
wherein the processing means comprises:
means for determining the differences in time referenced to the synchronized local time base.

29. A computer readable medium including software that is configured to control a general purpose computer to implement a method for determining a location of at least an image of a transmitter transmitting a signal with respect to a receiver having a plurality of at least three antennas separated by known distances for receiving the signal, the method including the steps of:
determining differences in time between receipt of the signal at one of the plurality of antennas and at least two of the other antennas; and
processing the known distances and the determined differences in time to determine the location of at least the image of the transmitter.

30. The computer implemented method of claim 29, wherein the transmitter is part of a sub-network within a network including a plurality of sub-networks and wherein the method for implementation by the general purpose computer further comprises the step of:
managing hand-offs between the sub-network and another sub-network in the plurality of sub-networks responsive to the determined location of at least the image of the transmitter.

31. The computer implemented method of claim 29, wherein the signal is an Ultra Wideband (UWB) signal and wherein the determining step for implementation by the general purpose computer further comprises the step of:
determining differences in time among receipt of the UWB signal at the plurality of antennas.

32. The computer implemented method of claim 29, wherein the method for implementation by the general purpose computer further comprises the steps of:
receiving a GPS time signal to synchronize a local time base in the receiver; and
wherein the processing step for implementation by the general purpose computer further comprises the step of:
determining the differences in time referenced to the synchronized local time base.
